(19) United States
(12) Patent Application Publication
(10) Pub. No.: US 2024/0349380 A1
(43) Pub. Date: Oct. 17, 2024

(54) METHOD AND APPARATUS FOR WIRELESS COMMUNICATION

(71) Applicant: Lenovo (Beijing) Limited, Beijing (CN)

(72) Inventors: Lianhai Wu, Beijing (CN); Yibin Zhuo, Beijing (CN); Hongmei Liu, Beijing (CN); Mingzeng Dai, Shanghai (CN)

(73) Assignee: Lenovo (Beijing) Limited, Beijing (CN)

(21) Appl. No.: 18/577,765

(22) PCT Filed: Jul. 16, 2021
(86) PCT No.: PCT/CN2021/106828

§ 371 Date: Jan. 9, 2024

(51) Int. Cl. H04W 76/19

(52) U.S. Cl. CPC H04W 76/19

(57) ABSTRACT

Embodiments of the present disclosure relate to wireless communication in an IAB network. According to some embodiments of the disclosure, a method performed by an IAB node may include: receiving, at a backhaul adaptation protocol (BAP) layer of the IAB node, a backhaul (BH) radio failure link (RLF) indication from a parent node of the IAB node, wherein the BH RLF indication indicates an RLF detection on a radio link between the parent node of the IAB node and a parent node of the parent node of the IAB node or the BH RLF recovery success on the same radio link.

### TECHNICAL FIELD

Embodiments of the present disclosure generally relate to wireless communication technology, and more particularly to wireless communication in an integrated access and backhaul (IAB) network.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for handling wireless communications in the IAB network.

### SUMMARY

Some embodiments of the present disclosure provide a method performed by an integrated access and backhaul (IAB) node. The method may include: receiving, at a backhaul adaptation protocol (BAP) layer of the IAB node, a first backhaul (BH) radio failure link (RLF) indication from a parent node of the IAB node, wherein the first BH RLF indication indicates an RLF detection on a radio link between the parent node of the IAB node and a parent node of the parent node of the IAB node.

In some embodiments of the present disclosure, the method may further include: receiving, at the BAP layer of the IAB node, a second BH RLF indication from the parent node of the IAB node, wherein the second BH RLF indication indicates an RLF recovery success on the radio link between the parent node of the IAB node and the parent node of the parent node of the IAB node. The second BH RLF indication may be indicated by a RLF type field of a BAP control packet data unit (PDU). The BAP control PDU may indicate an ID of a current serving cell of the parent node of the IAB node.

Some embodiments of the present disclosure provide a method performed by an integrated access and backhaul (IAB) node. The method may include: transmitting, at a backhaul adaptation protocol (BAP) layer of the IAB node, a first backhaul (BH) radio failure link (RLF) indication to a child IAB node of the IAB node, wherein the first BH RLF indication indicates an RLF detection on a radio link between the IAB node and a parent node of the IAB node.

The first BH RLF indication may be indicated by a RLF type field of a BAP control packet data unit (PDU).

In some embodiments of the present disclosure, the method may further include: transmitting, at the BAP layer of the IAB node, a second BH RLF indication to the child IAB node of the IAB node, wherein the second BH RLF indication may indicate an RLF recovery success on the radio link between the IAB node and a parent node of the IAB node. The second BH RLF indication may be indicated by a RLF type field of a BAP control packet data unit (PDU). The BAP control PDU may indicate an ID of a current serving cell of the IAB node.

The RLF type field of the BAP control PDU may include one bit to indicate an RLF detection or an RLF recovery success.

Some embodiments of the present disclosure provide an integrated access and backhaul (IAB) node. According to some embodiments of the present disclosure, the IAB node may include: a transceiver; and a processor coupled to the transceiver, wherein the transceiver and the processor may interact with each other so as to perform a method according to some embodiments of the present disclosure.

Some embodiments of the present disclosure provide an integrated access and backhaul (IAB) node. The IAB node may include: a processor; and a transceiver coupled to the processor, wherein the transceiver may be configured to receive, at a backhaul adaptation protocol (BAP) layer of the IAB node, a first backhaul (BH) radio failure link (RLF) indication from a parent node of the IAB node. The first BH RLF indication may indicate an RLF detection on a radio link between the parent node of the IAB node and a parent node of the parent node of the IAB node.

Some embodiments of the present disclosure provide an integrated access and backhaul (IAB) node. The IAB node may include: a processor; and a transceiver coupled to the processor, wherein the transceiver may be configured to transmit, at a backhaul adaptation protocol (BAP) layer of the IAB node, a first backhaul (BH) radio failure link (RLF) indication to a child IAB node of the IAB node. The first BH RLF indication may indicate an RLF detection on a radio link between the IAB node and a parent node of the IAB node.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate the deployment of the IAB node and can facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of handling a UL transmission in accordance with some embodiments of the present application;

FIG. 3 illustrates a flow chart of an exemplary procedure of wireless communications in accordance with some embodiments of the present disclosure;

FIG. 4 illustrates an exemplary BAP PDU format in accordance with some embodiments of the present disclosure; and

FIG. 5 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, 1000-times capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. On the other hand, the deployment of optical fiber is difficult and costly for these small stations. Therefore, an economical and convenient backhaul scheme is needed. Integrated Access and Backhaul (IAB) technology, whose access link(s) and backhaul link(s) both use wireless transmission solutions to avoid fiber deployment, provides ideas for solving the above problems.

In an IAB network, a relay node (RN) or an IAB node or a wireless backhaul node/device can provide wireless access services for UEs. That is, a UE can connect to an IAB donor relayed by one or more IAB nodes. And the IAB donor may also be called a donor node or a donor base station (e.g., DgNB, Donor gNodeB). In addition, the wireless link between an IAB donor and an IAB node, or the wireless link between different IAB nodes can be referred to as a “backhaul link.”

An IAB node may include an IAB mobile terminal (MT) part and an IAB distributed unit (DU) part. When an IAB node connects to its parent node (which may be another IAB node or an IAB donor), it can be regarded as a UE, i.e., the role of the MT. When an IAB node provides service to its child node (which may be another IAB node or a UE), it can be regarded as a network device, i.e., the role of the DU.

An IAB donor can be an access network element with a complete base station function, or an access a network element with a separate form of a centralized unit (CU) and a distributed unit (DU). The IAB donor may be connected to the core network (for example, connected to the 5G core network (5GC)), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the small coverage of a high frequency band, in order to ensure the coverage performance of the network, multi-hop networking may be adopted in an IAB network. Taking into account the requirements of service transmission reliability, IAB nodes can support dual connectivity (DC) or multi-connectivity to improve the reliability of transmission, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

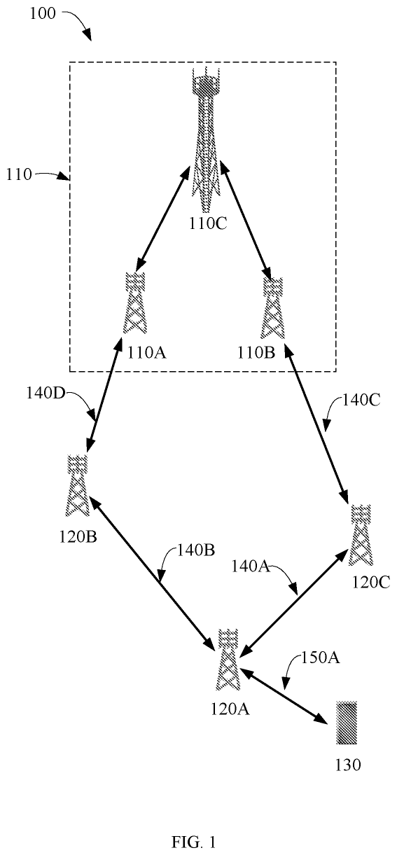

FIG. 1 illustrates a schematic diagram of a wireless communication system 100 in accordance with some embodiments of the present disclosure.

As shown in FIG. 1, the wireless communication system 100 may include a base station (e.g., IAB donor 110), some IAB nodes (e.g., IAB node 120A, IAB node 120B, and IAB node 120C), and a UE (e.g., UE 130). Although a specific number of UEs, IAB nodes, and IAB donors are depicted in FIG. 1, it is contemplated that any number of UEs, IAB nodes, and IAB donors may be included in the wireless communication system 100.

Each of IAB donor 110, IAB node 120A, IAB node 120B, and IAB node 120C may be directly connected to one or more IAB node(s) in accordance with some other embodiments of the present disclosure. Each of IAB donor 110, IAB node 120A, IAB node 120B, and IAB node 120C may be directly connected to one or more UEs in accordance with some other embodiments of the present disclosure.

UE 130 may be any type of device configured to operate and/or communicate in a wireless environment. For example, UE 130 may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present disclosure, UE 130 may include wearable devices, such as smart watches, fitness bands, optical head-mounted displays, internet-of-things (IoT) devices, or the like. Moreover, UE 130 may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donor 110 may include two DUs, i.e., DU 110A and DU 110B, and a CU 110C. It is contemplated that any number of DUs may be included in the IAB donor 110. IAB donor 110 may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donor 110 may transmit data using an orthogonal frequency division multiple (OFDM) modulation scheme on the DL. UE 130 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120B and IAB node 120C can be directly connected to IAB donor 110. For example, the MT (not shown in FIG. 1) of IAB node 120B may be connected to DU 110A and the MT (not shown in FIG. 1) of IAB node 120C may be connected to DU 110B.

IAB node 120A can reach IAB donor 110 by hopping through IAB node 120B or IAB node 120C. In some embodiments of the present disclosure, IAB node 120B and IAB node 120C may act as a master node (MN) and a secondary node (SN), respectively. An MN may be associated with a master cell group (MCG). An MCG may refer to a group of serving cells associated with the MN, and may include a primary cell (PCell) and optionally one or more secondary cells (SCells). An SN may be associated with a secondary cell group (SCG). An SCG may refer to a group of serving cells associated with the SN, and may include a primary secondary cell (PSCell) and optionally one or more secondary cells (SCells). The PCell of the MCG and the PSCell of the SCG may also be referred to as a special cell (SpCell). The radio link between IAB node 120A and IAB node 120B may be referred to as a MCG link, and the radio link between IAB node 120A and IAB node 120C may be referred to as a SCG link.

UE 130 can be connected to IAB node 120A. Uplink (UL) packets (e.g., data or signaling) from UE 130 can be transmitted to an IAB donor (e.g., IAB donor 110) via one or more IAB nodes, and then transmitted by the IAB donor to a mobile gateway device (such as the user plane function (UPF) in 5GC). Downlink (DL) packets (e.g., data or signaling) can be transmitted from the IAB donor (e.g., IAB donor 110) after being received by the gateway device, and then transmitted to UE 130 through one or more IAB nodes. For example, referring to FIG. 1, UE 130 may transmit UL data to IAB donor 110 or receive DL data therefrom via IAB node 120A.

In an IAB network, the neighbor node on the IAB DU's interface is referred to as a child node and the neighbor node on the IAB MT's interface is referred to as a parent node. The direction toward the child node is referred to as downstream while the direction toward the parent node is referred to as upstream. For example, IAB donor 110 is a parent node of IAB node 120B and IAB node 120C. In other words, IAB node 120B and IAB node 120C are child IAB nodes of IAB donor 110. IAB node 120B and IAB node 120C are parent IAB nodes of IAB node 120A. In other words, IAB node 120A is a child IAB node of IAB node 120B and IAB node 120C. IAB node 120A and UE 130 are downstream nodes of IAB node 120B and IAB node 120C.

In an IAB deployment such as the wireless communication system 100, the radio link between an IAB donor (e.g., IAB donor 110 in FIG. 1) and an IAB node or between two IAB nodes may be referred to as a backhaul link (BL). The radio link between an IAB donor (e.g., IAB donor 110 in FIG. 1) and a UE or between an IAB node and a UE may be referred to as an access link (AL). For example, in FIG. 1, radio links 140A to 140D are BLs and radio link 150 is an AL.

Although in FIG. 1, all IAB nodes are connected to IAB donor 110 via one or multiple hops, which forms a directed acyclic graph (DAG) topology with IAB donor 110 at its root, it should be understood that the embodiments of the present disclosure can be applied to IAB networks having different structures or topologies, without departing from the spirit and scope of the disclosure. For example, IAB node 120A may access IAB donor 110 via a signal connection (e.g., via IAB node 120B), and may not be connected to IAB node 120C.

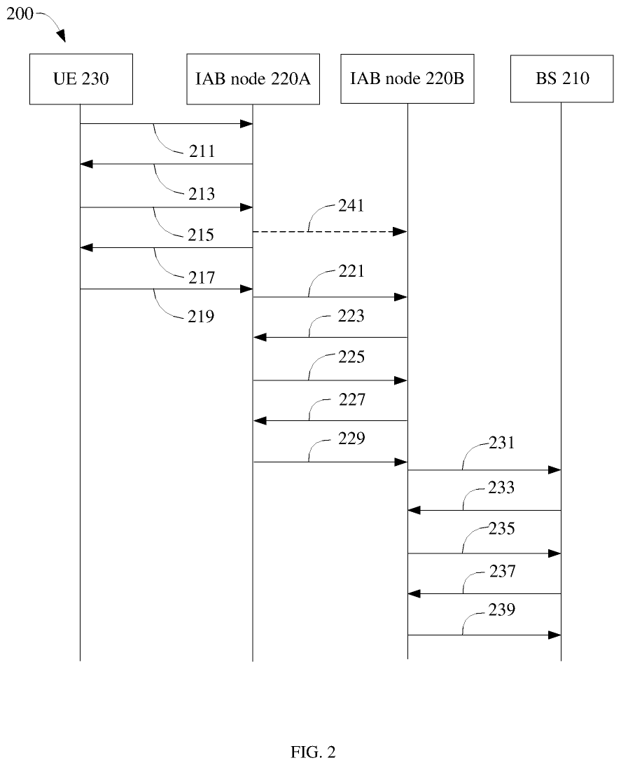

FIG. 2 illustrates a flow chart of an exemplary procedure 200 of handling a UL transmission in accordance with some embodiments of the present disclosure.

In FIG. 2, UE 230 can reach BS 210 by hopping through IAB node 220A and IAB node 220B. IAB node 220A can reach BS 210 by hopping through IAB node 220B. In some examples, IAB node 220B may function as IAB node 120B or IAB node 120C shown in FIG. 1. IAB node 220A, UE 230, and BS 210 may function as IAB node 120A, UE 130, IAB donor 110 shown in FIG. 1, respectively.

Referring to FIG. 2, UE 230 may have UL data to be transmitted on at least one logical channel. UE 230 may, in operation 211, trigger and transmit a scheduling request (SR) to its parent node (e.g., IAB node 220A) for requesting, for example, uplink shared channel (UL-SCH) resources. When an SR is triggered, it may be considered as pending until it is cancelled. For example, the SR may remain categorized as ‘pending’ after it has been transmitted. A pending SR may be cancelled, for example, after UE 230 has received an uplink resource allocation and has sent a corresponding buffer status report, or after UE 230 has received an uplink resource allocation and has been able to empty its transmission buffer(s).

In some embodiments of the present disclosure, an SR may be associated with the at least one logical channel having data for transmission. Each logical channel may be allocated to a logical channel group (LCG). The parameters for allocating the logical channels are defined in 3GPP specifications. A LCG may include at least one logical channel, for example, four logical channels.

In operation 213, UE 230 may receive a UL grant from IAB node 220A for a UL transmission. In operation 215, UE 230 may trigger and transmit a buffer status report (BSR) to IAB node 220A. UE 230 may start a retransmission BSR timer (e.g., a retxBSR-Timer) in response to the transmission of the BSR. UE 230 may trigger a retransmission of the BSR to IAB node 220A in response to an expiry of the retransmission BSR timer.

In some embodiments of the present disclosure, the BSR may be transmitted in a MAC control element (CE) of a MAC protocol data unit (PDU). Such MAC CE may also be referred to as a BSR MAC CE. In some embodiments of the present disclosure, a BSR may indicate buffer status (e.g., buffer size) for at least one logical channel group. The at least one logical channel group may include at least one logical channel. Each logical channel may correspond to a RLC channel (e.g., a data radio bearer (DRB) or an ingress RLC channel). The logical channels included in the at least one logical channel group may be hereinafter referred to logical channels associated with the BSR or logical channels included in the BSR.

In some examples, all triggered BSRs may be cancelled when the UL grant can accommodate all pending data available for transmission but is not sufficient to additionally accommodate the BSR MAC CE plus its subheader. In some examples, all BSRs triggered prior to the MAC PDU assembly may be cancelled when a MAC PDU is transmitted and this PDU includes a long or short BSR MAC CE which contains buffer status up to (and including) the last event that triggered a BSR prior to the MAC PDU assembly.

In response to the BSR from UE 230, IAB node 220A may allocate uplink resource for subsequent data transmission from UE 230. In operation 217, IAB node 220A may transmit to the UE 230 a UL grant for subsequent data transmission from UE 230. In operation 219, the UE 230 may transmit UL data to IAB node 220A with the uplink resource allocated by IAB node 220A.

After receiving a UL transmission from a child node (e.g. UE 230), IAB node 220A may perform a similar UL scheduling as described above with respect to operations 211-219.

For example, in operation 221, IAB node 220A may trigger and transmit an SR to its parent node (e.g., IAB node 220B). In operation 223, IAB node 220A may receive a UL grant from IAB node 220B for the UL data transmission. In operation 225, IAB node 220A may trigger and transmit a BSR to IAB node 220B. IAB node 220A may start a retransmission BSR timer (e.g., a retxBSR-Timer) in response to the transmission of the BSR. In operation 227, IAB node 220B may transmit to IAB node 220A a UL grant for the subsequent data transmission from IAB node 220A. In operation 229, IAB node 220A may transmit UL data to IAB node 220B with the uplink resource allocated by IAB node 220B.

After receiving a UL data transmission from a child node (e.g., IAB node 220A), IAB node 220B may perform a similar UL scheduling as described above with respect to operations 211-219 and operations 221-229.

For example, in operation 231, IAB node 220B may trigger and transmit an SR to its parent node (e.g., BS 210). In operation 233, IAB node 220B may receive a UL grant from the BS 210 for UL data transmission. In operation 235, IAB node 220B may trigger and transmit a BSR to BS 210. IAB node 220B may start a retransmission BSR timer (e.g., a retxBSR-Timer) in response to the transmission of the BSR. In operation 237, the BS 210 may transmit to IAB node 220B a UL grant for subsequent data transmission from IAB node 220B. In operation 239, IAB node 220B may transmit the UL data to the BS 210 with the uplink resource allocated by the BS 210.

In some embodiments of the present disclosure, when there are available UL resources (e.g., physical uplink shared channel (PUSCH) resources) for a UE or IAB node to send a BSR, an SR may be cancelled. In this scenario, operations 211, 213, 221, 223, 231 and 233 in FIG. 2 described above may be cancelled. When there are no available UL resources to send the BSR, an SR may be sent to a parent node to require the parent node to allocate resources, as described above with respect to operations 211, 213, 221, 223, 231 and 233 in FIG. 2.

In the exemplary procedure 200 shown in FIG. 2, a BSR may be triggered, for example, when UL data for a logical channel becomes available for transmission or when the retransmission BSR timer expires. For example, IAB node 220A may trigger and transmit a BSR to its parent node after receiving UL data from its child node. In this case, the received data may be stored in a buffer of IAB node 220A. Such BSR may be hereinafter referred to as a “regular BSR.”

In some embodiments of the present disclosure, a BSR may be triggered when a periodic BSR timer (e.g., a periodicBSR-Timer) expires. The periodic BSR timer may be configured via, for example, a radio resource control (RRC) signaling message. In this case, the BSR may be referred to as a “periodic BSR.”

In some embodiments of the present disclosure, a BSR may be triggered if UL resources are allocated and the number of padding bits is equal to or larger than the size of the BSR MAC CE plus its subheader. In this case, the BSR may be referred to as a “padding BSR.”

In some embodiments of the present disclosure, an IAB node may transmit a BSR to a parent node before the IAB node receives the UL data from its child node, which may reduce latency resulted from UL scheduling. In other words, such BSR may provide the amount of data expected to arrive at the IAB node. For example, an IAB node may transmit a BSR to its parent node after it receives an SR or a BSR from its child node and before receiving the corresponding UL data. For instance, referring to FIG. 2, in operation 241 (denoted by the dotted arrow as an example), IAB node 220A may transmit a BSR to IAB node 220B in response to the reception of a BSR from UE 230. Compared to the previously described BSRs (e.g., a regular BSR, a periodic BSR, and a padding BSR), which may provide the UL data volume in the MAC entity of an IAB node, the BSR transmitted in operation 241 may provide the amount of the data expected to arrive at IAB node 220A. Such BSR that is transmitted before the reception of the UL data from a child node are hereinafter referred to as “a pre-emptive BSR.” In the following context, if not specifically indicated, a BSR may refer to a regular BSR, a periodic BSR, or a padding BSR.

In some embodiments of the present disclosure, an IAB node may indicate link conditions of the BH link between the IAB node and its parent node to its downstream IAB node(s). Such indication may be referred to as a BH radio link failure (RLF) indication, and may indicate an RLF detection, a BH recovery, a recovery success, or a recovery failure according to the link condition.

For example, referring back to FIG. 1, when IAB node 120B detects an RLF of the link between IAB node 120B and IAB donor 110, IAB node 120B may transmit a BH RLF indication indicating an RLF detection to IAB node 120A. IAB node 120B may perform a recovery procedure, for example, a fast MCG link recovery or re-establishment procedure. When the recovery succeeds, IAB node 120B may transmit a BH RLF indication indicating a recovery success to IAB node 120A to indicate that the BH link has successfully recovered from the RLF. When the recovery fails, IAB node 120B may transmit a BH RLF indication indicating a recovery failure to IAB node 120A to indicate that the recovery of the BH link has failed.

Embodiments of the present disclosure provide solutions to enhance the wireless communication in an IAB network. For example, solutions for transmitting a BH RLF indication to an IAB node are provided. The IAB node may utilize the received BH RLF indication to optimize its processing flow. For instance, embodiments of the present disclosure provide solutions for handling pending SR, triggered BSR and triggered pre-emptive BSR in response to the reception of the BH RLF indication. More details on the embodiments of the present disclosure will be illustrated in the following text in combination with the appended drawings.

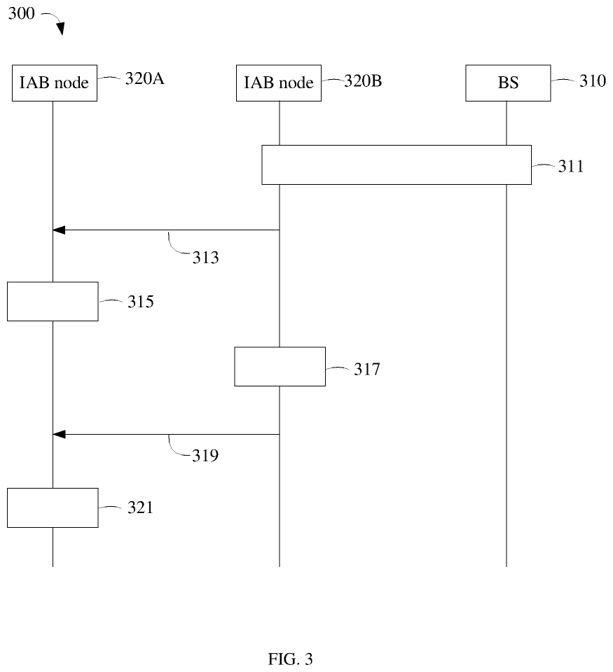

FIG. 3 illustrates a flow chart of an exemplary procedure 300 of wireless communications in accordance with some embodiments of the present disclosure. Details described in all of the foregoing embodiments of the present disclosure are applicable for the embodiments shown in FIG. 3. It should be appreciated by persons skilled in the art that the sequence of the operations in exemplary procedure 300 may be changed and some of the operations in exemplary procedure 300 may be eliminated or modified, without departing from the spirit and scope of the disclosure.

Referring to FIG. 3, IAB node 320A may access BS 310 (e.g., cell #A) via IAB 320B. In some examples, IAB 320A may access BS 310 via DC and IAB node 320B may be one of the two parent nodes. For instance, IAB node 320A may function as IAB node 120A in FIG. 1, IAB node 320B may function as IAB node 120B or IAB node 120C in FIG. 1, and BS 310 may function as BS 110 in FIG. 1. In some other examples, IAB 320A may access BS 310 via a single parent node (e.g., IAB 320B).

In operation 311, IAB node 320B may detect an RLF on the radio link between BS 310 (e.g., cell #A) and IAB node 320B. In operation 313, IAB node 320B may transmit a BH RLF indication to its child node(s), for example, IAB node 320A. The BH RLF indication indicates an RLF detection on the radio link between BS 310 and IAB node 320B, and may be hereinafter referred to as “RLF detection indication.”

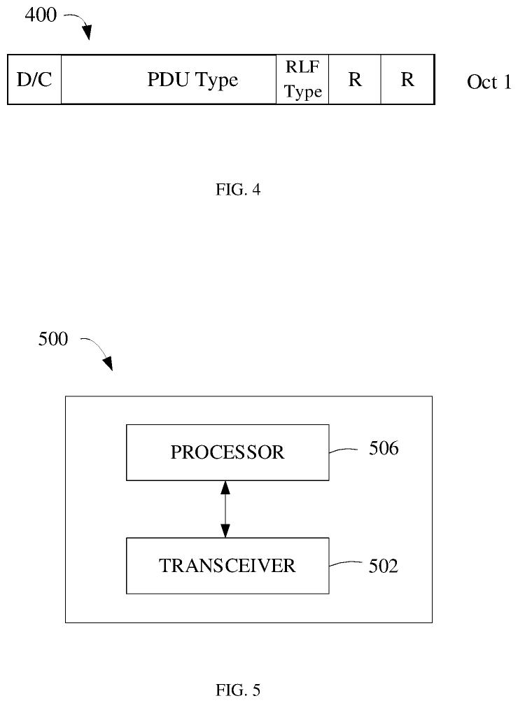

In some embodiments of the present disclosure, the RLF detection indication may be received at the BAP layer of IAB node 320A. For instance, the RLF detection indication may be included in a BAP control packet data unit (PDU), which may have a BAP PDU format as shown in FIG. 4.

As shown in FIG. 4, the BAP PDU 400 format can be octet aligned. The BAP PDU 400 can include 1 byte, which can be referred to as “Oct 1” in FIG. 4. The BAP PDU 400 may include more or fewer fields in some other embodiments of the present disclosure.

The BAP PDU 400 format may include several fields such as a “D/C” field, “PDU Type” field, a “RLF Type” field, and some “R” fields. In some examples, the “D/C” field may indicate whether the corresponding BAP PDU is a BAP data PDU or a BAP control PDU. The “PDU Type” field may indicate the type of control information included in the corresponding BAP control PDU. The “R” field may indicate a reserved bit(s). The “RLF Type” field may indicate the type of a BH RLF indication. For example, the “RLF Type” field may include one bit to indicate an RLF detection or an RLF recovery success. For instance, the value of the “RLF Type” field being “0” may indicate an RLF detection and the value of the “RLF Type” field being “1” may indicate an RLF recovery success; or vice versa.

Referring back to FIG. 3, in response to the reception of the RLF detection indication, IAB node 320A may, in operation 315, suspend the UL transmission to IAB node 320B.

In some examples, in the case that IAB node 320A only has a single parent node (e.g., IAB node 320B), IAB node 320A may stop broadcasting IAB supported information element (IE) in a system information block (SIB) in response to the reception of the RLF detection indication. In some examples, IAB node 320A may access a serving BS via multiple connections. For instance, in the case that IAB node 320A access BS 310 via DC (e.g., via IAB node 320B and another parent node) and the radio link between IAB node 320A and the another parent node (not shown in FIG. 3) is suspended (e.g., a RLF occurs), IAB node 320A may stop broadcasting IAB supported IE in a SIB in response to the reception of the RLF detection indication.

In some embodiments of the present disclosure, in response to the reception of the RLF detection indication, IAB node 320A may perform the measurement of a non-serving cell of IAB node 320A. In some examples, a threshold for triggering the measurement on a non-serving cell may be configured to IAB node 320A. IAB node 320A may ignore the threshold for triggering the measurement on the non-serving cell and may perform the measurement of a non-serving cell of IAB node 320A in response to the reception of the RLF detection indication regardless of the threshold.

For instance, IAB node 320A may be configured with an S-measure configuration, which may indicate a signal strength threshold (e.g., a reference signal received power (RSRP) value). Generally, when the channel quality of the serving cell (e.g., Spcell) of IAB node 320A is worse than the configured threshold, IAB node 320A is required to perform measurements on a non-serving cell(s). Otherwise, when the channel quality of the serving cell of IAB node 320A is better than the configured threshold, IAB node 320A is not required to perform measurements on a non-serving cell(s). However, in the exemplary procedure 300, IAB node 320A would perform the measurement of a non-serving cell in response to the reception of the RLF detection indication regardless of the threshold, if configured.

In some embodiments of the present disclosure, the RLF detection indication may be used to trigger the deactivation or reduction of SR, BSR, and pre-emptive BSR transmissions, which will described in detail in the following text.

In operation 317, IAB node 320B may perform a reestablishment procedure. For example, IAB node 320B may perform a conditional handover (CHO) procedure recovery or transmit a reestablishment request.

In some embodiments of the present disclosure, IAB node 320B may perform a successful recovery with cell #A of BS 310, a different cell (e.g., cell #B) of BS 310 or a cell (e.g., cell #C) of another BS. In response to the successful recovery, IAB node 320B may, in operation 319, transmit a BH RLF indication to IAB node 320A. The BH RLF indication indicates a successful recovery on the radio link between IAB node 320B and its parent node, and may be hereinafter referred to as “successful recovery indication.” In some other embodiments of the present disclosure, the recovery may fail, and IAB node 320B may transmit a BH RLF indication indicating a recovery failure to IAB node 320A.

In some embodiments of the present disclosure, the successful recovery indication may be received at the BAP layer of IAB node 320A. For instance, the successful recovery indication may be included in a BAP control PDU, which may have a BAP PDU format as shown in FIG. 4. In some embodiments, the RLF type field of the BAP control PDU may include one bit to indicate the successful recovery indication.

In some embodiments of the present disclosure, the BAP control PDU may indicate the ID of the current serving cell (e.g., cell #A, cell #B, or cell #C) of IAB node 320B. Informing the current serving cell of IAB node 320B to IAB node 320A would be beneficial because IAB node 320A can determine whether a reestablishment procedure is needed and to which cell the reestablishment request is to be transmitted.

In response to the reception of the successful recovery indication, IAB node 320A may, in operation 321, resume the UL transmission to IAB node 320B. For example, IAB node 320A may transmit UL data based on received UL grant(s).

In some embodiments of the present disclosure, IAB node 320A may determine whether the ID of its serving cell is the same as the one indicated in the successful recovery indication. In the case that the cell IDs are different, IAB node 320A may transmit a reestablishment request to the cell indicated in the successful recovery indication. Otherwise, in the case that the cell IDs are the same, the reestablishment procedure may not be needed, and IAB node 320A may resume the UL transmission to IAB node 320B.

In some embodiments of the present disclosure, IAB node 320A may broadcast IAB supported IE in a SIB in response to the reception of the successful recovery indication. In some embodiments of the present disclosure, in response to the reception of the successful recovery indication, IAB node 320A may perform the measurement of a non-serving cell of IAB node 320A when the channel quality of the serving cell (e.g., Spcell) of IAB node 320A is worse than the threshold for triggering a measurement on a non-serving cell.

In some embodiments of the present disclosure, the successful recovery indication may be used to trigger the activation of SR, BSR, and pre-emptive BSR transmissions, which will described in detail in the following text.

As mentioned above, the BH RLF indication (e.g., the RLF detection indication or the successful recovery indication) may be used to handling the pending SR and triggered BSR and pre-emptive BSR at an IAB node.

In some examples, IAB node 320A may stop the periodic BSR timer associated with IAB node 320B in response to the reception of the RLF detection indication. IAB node 320A may stop a retransmission BSR timer associated with IAB node 320B in response to the reception of the RLF detection indication. IAB node 320A may start the periodic BSR timer associated with IAB node 320B in response to the reception of the successful recovery indication.

In some examples, in response to the reception of the RLF detection indication, IAB node 320A may cancel all pending SRs, all triggered BSRs, and all triggered pre-emptive BSRs associated with IAB node 320B. For example, a BSR that is triggered to be transmitted to IAB node 320B for a UL grant may be cancelled. In some embodiments of the present disclosure, IAB node 320A may prohibit the triggering of any of a SR. BSR and pre-emptive BSR associated with IAB node 320B in response to the reception of the RLF detection indication. That is, any of an SR, BSR and pre-emptive BSR to IAB node 320B may not be allowed to be triggered.

In response to the reception of the successful recovery indication, the SR, BSR and pre-emptive BSR may be allowed to be triggered and transmitted to IAB node 320B. For example, IAB node 320A may trigger and transmit at least one of a BSR and a pre-emptive BSR associated with IAB node 320B in response to the reception of the successful recovery indication

In some examples, in response to the reception of the RLF detection indication, IAB node 320A may cancel all pending SRs associated with IAB node 320B. IAB node 320A may keep the triggered BSR(s) and triggered pre-emptive BSR(s) associated with IAB node 320B. In other words, IAB node 320A may prohibit the transmission of any of a triggered BSR and a triggered pre-emptive BSR to IAB node 320B. A BSR or pre-emptive BSR may still be allowed to be triggered after the reception of the RLF detection indication.

In response to the reception of the successful recovery indication, an SR, BSR and pre-emptive BSR may be allowed to be transmitted to IAB node 320B. For example, IAB node 320A may transmit at least one of a pending SR, a triggered BSR and a triggered pre-emptive BSR associated with IAB node 320B in response to the reception of the successful recovery indication.

For instance, when a UL grant during a random access procedure can accommodate the triggered BSR, IAB node 320A may transmit the triggered BSR. Otherwise, IAB node 320A may transmit a pending SR associated with the BSR, or trigger and transmit an SR associated with the BSR. In some cases, when a UL grant during a random access procedure can accommodate the triggered pre-emptive BSR. IAB node 320A may transmit the triggered pre-emptive BSR. Otherwise, IAB node 320A may transmit a pending SR associated with the pre-emptive BSR, or trigger and transmit an SR associated with the pre-emptive BSR.

In some examples, in response to the reception of the RLF detection indication, IAB node 320A may keep the pending SR(s), the triggered BSR(s) and triggered pre-emptive BSR(s) associated with IAB node 320B. In other words, IAB node 320A may prohibit transmission of any of a pending SR, a triggered BSR and a triggered pre-emptive BSR to IAB node 320B. A BSR or pre-emptive BSR may be allowed to be triggered in response to the reception of the RLF detection indication.

In response to the reception of the successful recovery indication, an SR, BSR and pre-emptive BSR may be allowed to be transmitted to IAB node 320B. For example, IAB node 320A may transmit at least one of a pending SR, a triggered BSR and a triggered pre-emptive BSR associated with IAB node 320B in response to the reception of the successful recovery indication.

In some examples, in response to the reception of the RLF detection indication, IAB node 320A may perform a local rerouting procedure to reroute buffered data associated with IAB node 320B. For example, referring back to FIG. 1, when a RLF occurs on the BH link between IAB node 120B and IAB donor 110, IAB node 120A may reroute buffered data associated with IAB node 120B to IAB node 120C.

Referring back to FIG. 3, in some cases, all buffered data associated with IAB node 320B may be rerouted. IAB node 320A may then cancel all pending SRs, all triggered BSRs, and all triggered pre-emptive BSRs associated with IAB node 320B.

In some cases, some of the buffered data associated with IAB node 320B may be rerouted. For examples, all buffered data associated with a DRB between IAB node 320A and IAB node 320B may be rerouted. IAB node 320A may cancel all pending SRs, all triggered BSRs, and all triggered pre-emptive BSRs associated with the DRB. For example, IAB node 320A may cancel a triggered BSR in the case that the DRB corresponds to one of the logical channels included in the triggered BSR.

FIG. 5 illustrates a block diagram of an exemplary apparatus 500 according to some embodiments of the present disclosure.

As shown in FIG. 5, the apparatus 500 may include at least one processor 506 and at least one transceiver 502 coupled to the processor 506. The apparatus 500 may be a BS (e.g., an IAB donor) or an IAB node.

Although in this figure, elements such as the at least one transceiver 502 and processor 506 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be an IAB node. The transceiver 502 and the processor 506 may interact with each other so as to perform the operations with respect to the IAB nodes described in FIGS. 1-3.

In some embodiments of the present application, the apparatus 500 may be a BS (e.g., an IAB donor). The transceiver 502 and the processor 506 may interact with each other so as to perform the operations with respect to the BSs or IAB donors described in FIGS. 1-3.

In some embodiments of the present application, the apparatus 500 may further include at least one non-transitory computer-readable medium.

For example, in some embodiments of the present disclosure, the non-transitory computer-readable medium may have stored thereon computer-executable instructions to cause the processor 506 to implement the method with respect to the IAB nodes as described above. For example, the computer-executable instructions, when executed, cause the processor 506 interacting with transceiver 502, so as to perform the operations with respect to the IAB nodes described in FIGS. 1-3.

In some embodiments of the present disclosure, the non-transitory computer-readable medium may have stored thereon computer-executable instructions to cause the processor 506 to implement the method with respect to the BSs or IAB donors as described above. For example, the computer-executable instructions, when executed, cause the processor 506 interacting with transceiver 502, so as to perform the operations with respect to the BSs or IAB donors described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A method performed by an integrated access and backhaul (IAB) node, the method comprising:
receiving, at a backhaul adaptation protocol (BAP) layer of the IAB node, a first backhaul (BH) radio failure link (RLF) indication from a parent node of the IAB node, and
the first BH RLF indication indicating an RLF detection on a radio link between the parent node of the IAB node and a parent node of the parent node of the IAB node.

2-15. (canceled)

16. An integrated access and backhaul (IAB) node for wireless communication, comprising:
at least one memory; and
at least one processor coupled with the at least one memory and configured to cause the IAB node to:
receive, at a backhaul adaptation protocol (BAP) layer of the IAB node, a first backhaul (BH) radio failure link (RLF) indication from a parent node of the IAB node, and
the first BH RLF indication indicating an RLF detection on a radio link between the parent node of the IAB node and a parent node of the parent node of the IAB node.

17. The IAB node of claim 16, wherein the at least one processor is configured to cause the IAB node to, in response to reception of the first BH RLF indication:
cancel all pending scheduling requests (SRs), all triggered buffer status reports (BSRs), and all triggered pre-emptive BSRs associated with the parent node of the IAB node;
cancel all pending SRs associated with the parent node of the IAB node, and prohibit transmission of any of a triggered BSR and a triggered pre-emptive BSR to the parent node of the IAB node; and
prohibit transmission of any of a pending scheduling request (SR), a triggered buffer status report (BSR) and a triggered pre-emptive BSR to the parent node of the IAB node.

18. The IAB node of claim 16, wherein the at least one processor is configured to cause the IAB node to:
stop a periodic buffer status report (BSR) timer associated with the parent node of the IAB node in response to reception of the first BH RLF indication; and
stop a retransmission BSR timer associated with the parent node of the IAB node in response to the reception of the first BH RLF indication.

19. The IAB node of claim 16, wherein the at least one processor is configured to cause the IAB node to:
prohibit triggering of any of a scheduling request (SR), a buffer status report (BSR), and a pre-emptive BSR associated with the parent node of the IAB node.

20. The IAB node of claim 16, wherein the at least one processor is configured to cause the IAB node to:
receive, at the BAP layer of the IAB node, a second BH RLF indication from the parent node of the IAB node, wherein the second BH RLF indication indicates an RLF recovery success on the radio link between the parent node of the IAB node and the parent node of the parent node of the IAB node.

21. The IAB node of claim 20, wherein the at least one processor is configured to cause the IAB node to:
start a periodic buffer status report (BSR) timer associated with the parent node of the IAB node in response to reception of the second BH RLF indication.

22. The IAB node of claim 20, wherein the at least one processor is configured to cause the IAB node to one or both of:
trigger at least one of a buffer status report (BSR) and a pre-emptive BSR associated with the parent node of the IAB node in response to reception of the second BH RLF indication; and
transmit at least one of a pending scheduling request (SR), a triggered BSR and a triggered pre-emptive BSR associated with the parent node of the IAB node in response to the reception of the second BH RLF indication.

23. The IAB node of claim 16, wherein the at least one processor is configured to cause the IAB node to:
reroute buffered data associated with the parent node of the IAB node in response to reception of the first BH RLF indication.

24. The IAB node of claim 23, wherein the at least one processor is configured to cause the IAB node to:
in response to all buffered data associated with the parent node of the IAB node being rerouted, cancel all pending scheduling requests (SRs), all triggered buffer status reports (BSRs), and all triggered pre-emptive BSRs associated with the parent node of the IAB node; and
in response to all buffered data associated with a data radio bearer (DRB) between the IAB node and the parent node of the IAB node being rerouted, cancel at least one of a pending scheduling request (SR), a triggered buffer status report (BSR) and a triggered pre-emptive BSR associated with the DRB.

25. The IAB node of claim 16, wherein the at least one processor is configured to cause the IAB node to, in response to reception of the first BH RLF indication, at least one of:
suspend uplink (UL) data transmission to the parent node of the IAB node;
perform measurement of a non-serving cell of the IAB node; or
stop broadcasting IAB supported information element (IE) in a system information block (SIB) when the IAB node accesses a serving donor base station (BS) via a dual connection and a radio link between the IAB node and another parent node is suspended.

26. The IAB node of claim 25, wherein to perform the measurement of the non-serving cell of the IAB node comprises ignoring a threshold for triggering a measurement on a non-serving cell.

27. The IAB node of claim 20, wherein the at least one processor is configured to cause the IAB node to, in response to reception of the second BH RLF indication, at least one of:
resume uplink (UL) data transmission to the parent node of the IAB node;
perform measurement of a non-serving cell of the IAB node when a channel quality of a serving cell of the IAB node is worse than a threshold for triggering a measurement on a non-serving cell; or
broadcast IAB supported information element (IE) in a system information block (SIB).

28. The IAB node of claim 16, wherein the first BH RLF indication is indicated by a RLF type field of a BAP control packet data unit (PDU).

29. The IAB node of claim 20, wherein the second BH RLF indication is indicated by a RLF type field of a BAP control packet data unit (PDU).

30. The IAB node of claim 28, wherein the RLF type field of the BAP control PDU includes one bit to indicate an RLF detection or an RLF recovery success.

31. The IAB node of claim 29, wherein the RLF type field of the BAP control PDU includes one bit to indicate an RLF detection or an RLF recovery success.

32. An integrated access and backhaul (IAB) node for wireless communication, comprising:
at least one memory; and
at least one processor coupled with the at least one memory and configured to cause the IAB node to:
transmit, from a backhaul adaptation protocol (BAP) layer of the IAB node, a first backhaul (BH) radio failure link (RLF) indication to a child IAB node of the IAB node, and
the first BH RLF indication indicating an RLF detection on a radio link between the IAB node and a parent node of the IAB node.

33. The IAB node of claim 32, wherein the at least one processor is configured to cause the IAB node to:
transmit, from the BAP layer of the IAB node, a second BH RLF indication to the child IAB node of the IAB node, wherein the second BH RLF indication indicates an RLF recovery success on the radio link between the IAB node and a parent node of the IAB node.

34. A method performed by an integrated access and backhaul (IAB) node for wireless communication, the method comprising:
transmitting, from a backhaul adaptation protocol (BAP) layer of the LAB node, a first backhaul (BH) radio failure link (RLF) indication to a child IAB node of the LAB node, and
the first BH RLF indication indicating an RLF detection on a radio link between the IAB node and a parent node of the IAB node.
